(19) United States
(12) Patent Application Publication
(10) Pub. No.: US 2026/0240371 A1
(43) Pub. Date: Aug. 20, 2026

(54) HEAT RESISTANT HANDLE WHICH CAN STAND POT LID

(71) Applicant: Joo Yeun Han, Seongnam-si (KR)

(72) Inventor: Joo Yeun Han, Seongnam-si (KR)

(21) Appl. No.: 19/164,813

(22) PCT Filed: Mar. 28, 2024
(86) PCT No.: PCT/KR2024/003897

§ 371 Date: Sep. 12, 2025

(30) Foreign Application Priority Data
Mar. 30, 2023 (KR) 10-2023-0042175
Mar. 20, 2024 (KR) 10-2024-0038204

(51) Int. Cl. A47J 45/10; A47J 47/16

(52) U.S. Cl. CPC A47J 45/10; A47J 47/16

(57) ABSTRACT

An embodiment of the present invention provides a heat-resistant holder including a support surface; an insertion part formed to have a shape that protrudes from one surface of the support surface; and an outer wall formed to protrude along an edge of the support surface, wherein a handle of a pot lid is inserted from the other surface of the support surface into the insertion part, and the outer wall, which protrudes from the support surface, is configured to be open in one direction to allow a user's hand to enter and exit.

### FIELD OF THE INVENTION

The present invention relates to a heat-resistant holder having a pot lid holding function, and more particularly, to a heat-resistant holder for safely holding a hot pot lid handle and placing the pot lid while maintaining a state in which the pot lid handle is held.

### BACKGROUND OF THE INVENTION

Generally, a heat-resistant holder consists of a pair of holders accommodating the thumb and the remaining fingers or has a mitten-like structure. A user spreads the holders to hold a hot pot body handle or a hot pot lid handle.

Meanwhile, a pot lid organizer is used to store a pot lid after washing it or to temporarily place a hot lid.

When temporarily placing a pot lid, a user has to wear a heat-resistant holder to hold a handle of the pot lid and temporarily store the pot lid in a pot lid organizer, and when putting the pot lid back on, the user has to wear the heat-resistant holder, which the user has taken off, again to hold the handle of the pot lid, and thus there is an inconvenience that the user has to wear and take off the heat-resistant holder each time.

Further, when there is no pot lid organizer, a user may often burn his or her hand in a process of putting a pot lid upside down on a kitchen countertop to prevent water from flowing down from the pot lid or grabbing the pot lid again.

### SUMMARY

The present invention is for addressing the above-described problems of the related art.

The present invention is directed to providing a heat-resistant holder having convenience in use to safely hold a hot pot lid handle and place the pot lid while maintaining a state in which the pot lid handle is held.

The objectives of the present invention are not limited to the above-mentioned objectives, and other unmentioned objectives may become more apparent based on the following description.

One embodiment of the present invention provides a heat-resistant holder including a support surface; an insertion part formed to have a shape that protrudes from one surface of the support surface; and an outer wall formed to protrude along an edge of the support surface, wherein a handle of a pot lid is inserted from the other surface of the support surface into the insertion part, and the outer wall, which protrudes from the support surface, is configured to be open in one direction to allow a user's hand to enter and exit.

According to the technical spirit of the present disclosure, a heat-resistant holder allowing a hot pot lid handle to be safely held can be provided

According to the technical spirit of the present disclosure, a pot lid can be easily held or placed on the ground in a state in which a handle of the pot lid is inserted.

According to the technical spirit of the present disclosure, a user can protect his or her hands from burns when holding a handle of a pot lid and placing the pot lid and can prevent burns by using the heat-resistant holder also when putting the pot lid, which is still hot, back on.

More specifically, according to the technical spirit of the present disclosure, through a structure of an insertion part, which allows a hot pot lid handle to be inserted thereinto and held, and a structure of an outer wall, which protrudes to be open in any one direction and blocked in the other directions, there are advantageous effects that a user's hand can freely enter and exit, grab the insertion part, and be prevented from burns caused by a high temperature of the pot lid.

In addition, according to the technical spirit of the present disclosure, since the height of the uppermost end of the outer wall is formed to be uniform throughout or vary according to positions while being higher than the insertion part, there is an advantageous effect that it is easy for a user to take out his or her hand after, while grabbing a pot lid handle, flipping his or her hand, bringing the outer wall into contact with the ground, and placing the pot lid and the heat-resistant holder at a certain angle, and then put his or her hand back in the heat-resistant holder.

Further, according to the technical spirit of the present disclosure, an area of a portion of the insertion part that comes into contact with a support surface can be further expanded through one or more cutting portions formed in a region where the support surface and the insertion part are connected, and accordingly, there is an advantageous effect that it becomes possible to grab a lid handle having a large size.

### BRIEF DESCRIPTION OF FIGURES

FIG. 1 illustrates a top perspective view of a heat-resistant holder having a pot lid holding function according to one embodiment of the present invention.

FIG. 2 illustrates a bottom perspective view of the heat-resistant holder having a pot lid holding function according to one embodiment of the present invention.

FIG. 3 illustrates a use state of the heat-resistant holder having a pot lid holding function according to one embodiment of the present invention.

### DETAILED DESCRIPTION OF THE DISCLOSURE

In order to achieve the above objectives, one embodiment of the present invention provides a heat-resistant holder including a support surface; an insertion part formed to have a shape that protrudes from one surface of the support surface; and an outer wall formed to protrude along an edge of the support surface, wherein a handle of a pot lid is inserted from the other surface of the support surface into the insertion part, and the outer wall, which protrudes from the support surface, is configured to be open in one direction to allow a user's hand to enter and exit.

A thickness of the insertion part may be smaller than a thickness of the outer wall.

A height at which the insertion part protrudes may be configured to be lower than a height at which the outer wall protrudes.

A height of an uppermost end of the outer wall may be formed to vary according to positions in at least one region.

The outer wall may include a front outer wall that protrudes from a front edge of the support surface and a left outer wall and a right outer wall that protrude from a left side surface and a right side surface, respectively, of the support surface to face each other.

Heights at which the left outer wall and the right outer wall protrude may gradually increase away from the front outer wall.

One or more cutting portions for expansion of the insertion part may be formed in a region where the insertion part and the support surface come into contact.

The heat-resistant holder may further include a wing extending to protrude to the other side of the support surface.

The insertion part may include a corrugated structure formed inside of the insertion part.

Hereinafter, exemplary embodiments of the present disclosure will be described in detail with reference to the accompanying drawings. Advantages and features of the present disclosure and methods of achieving the same should become clear with embodiments described in detail below with reference to the accompanying drawings. However, the technical spirit of the present disclosure is not limited to the following embodiments and may be implemented in various different forms. The following embodiments are only provided to make the technical spirit of the present disclosure complete and completely inform those of ordinary skill in the art to which the present disclosure pertains of the scope of the present disclosure, and the technical spirit of the present disclosure is defined only by the scope of the claims.

In assigning reference numerals to components of each drawing, it should be noted that the same reference numerals are assigned to the same components wherever possible even when the components are illustrated in different drawings. Also, in describing the present disclosure, when it is determined that the detailed description of a known related configuration or function may obscure the gist of the present disclosure, the detailed description thereof will be omitted.

Unless otherwise defined, all terms including technical or scientific terms used herein have the same meaning as commonly understood by those of ordinary skill in the art to which the present disclosure pertains. In addition, terms defined in commonly used dictionaries should not be interpreted in an idealized or overly formal sense unless expressly so defined herein. Terms used herein are for describing the embodiments and are not intended to limit the present disclosure. In the specification, a singular expression includes a plural expression unless the context clearly indicates otherwise.

Also, in describing components of the present disclosure, terms such as first, second, A, B, (a), and (b) may be used. Such terms are only used for distinguishing one component from another component, and the essence, order, sequence, or the like of the corresponding component is not limited by the terms. In a case in which a certain component is described as being “connected,” “coupled,” or “linked” to another component, it should be understood that, although the component may be directly connected or linked to the other component, still another component may also be “connected,” “coupled,” or “linked” between the two components.

The terms “comprises” and/or “comprising” used herein do not preclude the presence or addition of one or more components, steps, operations, and/or devices other than those mentioned.

A component including a common function with a component included in any one embodiment may be described using the same name in another embodiment. Unless the context clearly indicates otherwise, description made in any one embodiment may apply to another embodiment, and detailed description may be omitted in a repeated range or a range that is self-evident to those of ordinary skill in the art.

Hereinafter, the present invention will be described in detail using exemplary embodiments of the present invention with reference to the accompanying drawings.

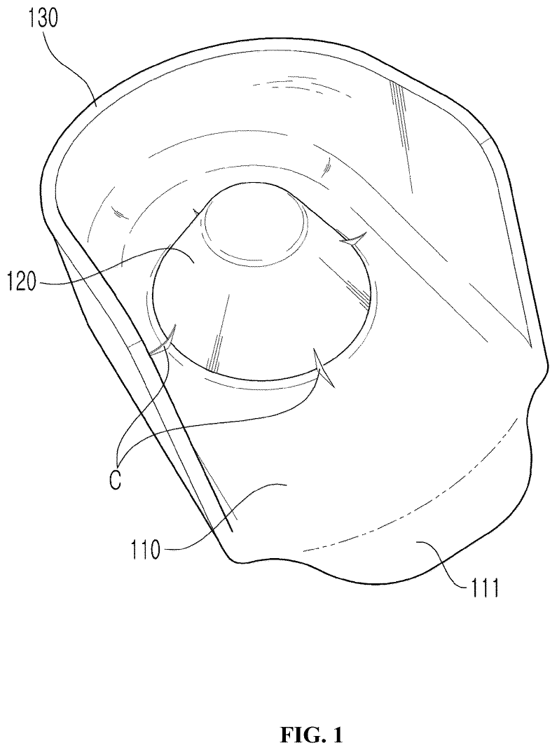

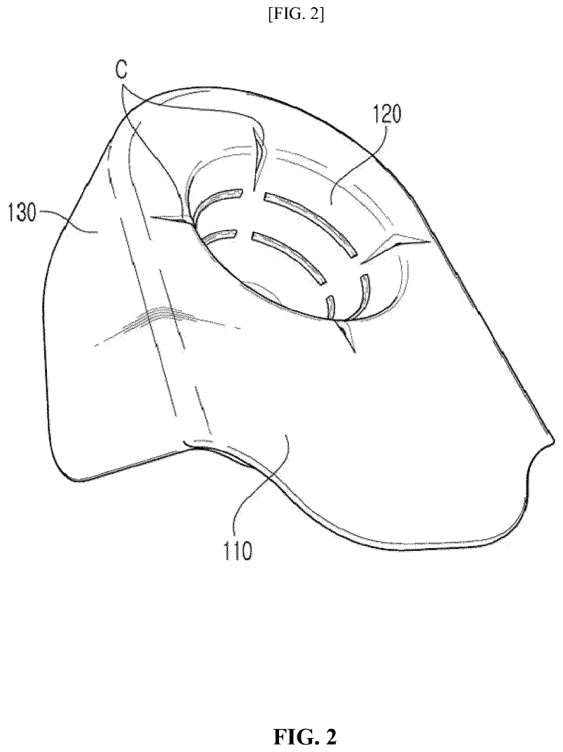

FIG. 1 illustrates a top perspective view of a heat-resistant holder having a pot lid holding function according to one embodiment of the present invention, and FIG. 2 illustrates a bottom perspective view of the heat-resistant holder having a pot lid holding function according to one embodiment of the present invention.

Referring to FIGS. 1 and 2, a heat-resistant holder according to one embodiment includes a support surface 110, an insertion part 120 formed to protrude from one surface of the support surface 110, and an outer wall 130 that vertically extends from an edge of the support surface 110.

Hereinafter, although the support surface 110, the insertion part 120, and the outer wall 130 are described as different components for the sake of convenience of description, the components may be integrally formed.

The support surface 110 may be formed in an elliptical shape from which a portion is cut out, but is not limited thereto. Preferably, the support surface 110 may have a shape in which a semi-circular shape is connected to one side that is relatively short among four sides of a rectangular shape. Here, a linear portion of the semi-circular shape is in contact with the one side.

Hereinafter, for convenience of description, a side of the support surface 110 where the semi-circular shape is formed will be referred to as “one side,” and the opposite side will be referred to as “the other side.”

The insertion part 120 that protrudes from one surface of the support surface 110 in a vertical direction is formed on at least a portion of the support surface 110. The insertion part 120 may be formed in a cylindrical shape or a conical shape from which an end portion is partially cut out. An example in which the insertion part 120 is formed in a conical shape from which a sharp end portion is partially cut out is illustrated in FIGS. 1 and 2. Specifically, in the example of FIGS. 1 and 2, the insertion part 120 may include an upper surface and a side surface that extends from an edge of the upper surface to the support surface 110.

The insertion part 120 is formed to be hollow, and a region of the support surface 110 where the insertion part 120 is formed is open. In other words, as illustrated in FIG. 2, a concave shape is formed from the other surface of the support surface 110 toward an inner surface of the insertion part 120, and a handle of a pot lid can be inserted from the other surface of the support surface 110 into the insertion part 120.

The insertion part 120 may be formed of a different material from other regions, e.g., formed of a thinner material than the other regions, or formed in a net-like shape. This is to add flexibility to the insertion part 120 so that the user can insert a pot lid handle into the insertion part 120 and safely hold the lid handle.

Meanwhile, the outer wall 130 that extends in a direction perpendicular to the support surface 110 is formed on a portion where both side edges of the support surface 110 are connected to another side edge thereof. The direction in which the outer wall 130 extends may be the same as the direction in which the insertion part 120 protrudes. That is, the insertion part 120 and the outer wall 130 may extend from the one surface of the support surface 110 in the same direction. Specifically, while the outer wall 130 is formed along the edge of the support surface 110, the outer wall 130 protruding from the support surface 110 may be configured to be open in one direction to allow a user's hand to enter and exit. For example, the outer wall 130 may be configured to be formed on the one side and both side surfaces of the support surface 110 and to not be formed on the other side of the support surface 110 so that the outer wall 130 and the support surface 110 form a space for protecting the user's hand, and a passage for the user's hand to enter and exit is formed at the other side of the support surface 110 where the outer wall 130 is not formed, and in this way, usability can be improved. A height from the support surface 110 to an uppermost end of the outer wall 130 may be formed to be uniform throughout or vary according to positions. Preferably, the height may be formed to gradually increase from the semi-circular shape of the support surface 110 toward a region where a wing 111 is formed. This is to make it easy for a user to take out his or her hand after, while grabbing the insertion part 120 by hand, that is, while a handle of a pot lid is inserted into the insertion part 120, flipping the hand, bringing the outer wall 130 into contact with the ground, and placing the pot lid. Like when taking the hand out, putting the hand back in the heat-resistant holder to use the pot lid may also be easy.

The outer wall 130 may include a front outer wall that protrudes from an edge of a front surface (the one side) of the support surface and a left outer wall and a right outer wall that protrude from a left side surface and a right side surface, respectively, of the support surface. Here, for example, the case in which the height of the uppermost end of the outer wall 130 is formed to vary according to positions may include a case in which the heights of the left outer wall and the right outer wall are different from each other. For example, the case in which the height of the uppermost end of the outer wall 130 is formed to vary according to positions may include a case in which the height of the left outer wall is lower or higher than the height of the right outer wall.

Alternatively, the case in which the height of the uppermost end of the outer wall 130 is formed to vary according to positions may include a structure in which the left outer wall and the right outer wall gradually protrude and become higher from the one side toward the other side (from the front surface toward a rear surface) while having structures symmetrical to each other. As compared to when the height of the uppermost end is uniform throughout, such a structure allows the pot lid to be more stably placed when the user brings the outer wall 130 into contact with the ground by flipping the hand while grabbing the insertion part 120 by hand, that is, while the handle of the pot lid is inserted into the insertion part 120, and the possibility that the user may burn his or her hand may also be more easily prevented structurally.

In addition, in terms of functionality, the outer wall 130 is not only for protecting the user's hand but also for allowing the user to place a pot lid, which may be heavy, in an upside-down state and thus needs to have a sufficient stiffness so as not to be deformed or damaged due to the weight of the pot lid. On the other hand, the insertion part 120 is for allowing the user to grab a pot lid by hand and thus needs to be relatively flexible to allow various pot lids to be grabbed regardless of the shape, and accordingly, it may be advantageous for the insertion part 120 to have a thickness that is smaller than the thickness of the outer wall 130. Further, in consideration of the case in which the temperature of a pot lid is high, it may be preferable to select a material that has excellent heat resistance despite being thin.

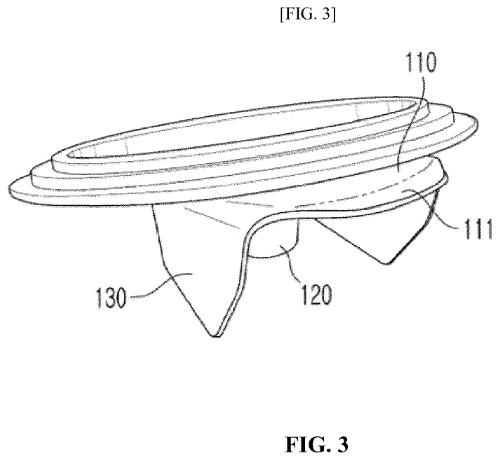

Meanwhile, the wing 111 may be formed at the other side of the support surface 110. The wing 111 is for preventing the user from burning his or her hand due to a hot pot lid when putting his or her hand in and out of the heat-resistant holder, and the wing 111 may be formed in a shape that extends from a portion of the other side of the support surface 110 in a direction parallel to the support surface 110. However, the present invention is not limited to such an embodiment, and the wing 111 may be formed to be bent at a predetermined angle instead of being completely parallel to the support surface 110 when extending from the other side of the support surface 110. For example, referring to FIG. 3, the wing 111 may be configured to be bent at a predetermined angle from the other side of the support surface 110 in a direction identical to the direction in which the outer wall 130 extends. The wing 111 may have a predetermined angle and length so that the angle is not high to the extent that insertion of the user's hand is interfered with, and the user's hand is prevented from coming into contact with a protruding portion of a pot lid. The wing having the predetermined angle and length may also be formed in a direction opposite to the direction in which the outer wall extends. This may also have an effect of preventing the user's hand from coming into contact with a pot lid.

In addition, referring to FIGS. 1 and 2, one or more cutting portions C may be formed in a region where the support surface 110 and the insertion part 120 are connected.

In FIGS. 1 and 2, a case in which a lower end of the insertion part 120 is formed in a circular shape, and four cutting portions C are formed at 90° intervals along an edge of the circular shape is illustrated.

Each cutting portion C may be formed to be perpendicular to a line at which the insertion part 120 and the support surface 110 come into contact.

The cutting portions C each have a shape that protrudes in the longitudinal direction thereof in the direction in which the insertion part 120 protrudes. When the support surface 110 is viewed from the bottom, the cutting portions C are each formed in the shape of a groove or a concave portion in a portion of the support surface 110 and a portion of the insertion part 120 with respect to the region (point) where the support surface 110 and the insertion part 120 come into contact.

In addition, the cutting portions C may be provided to be cut according to the user's will. In this case, regions where the cutting portions C are formed may be formed with a smaller thickness than other portions in order to be elastically stretchable or may be formed by being actually cut.

Since the cutting portions C are formed, an area of a portion of the insertion part 120 that comes into contact with the support surface 110 may be further expanded, and accordingly, even a lid handle having a large size may be inserted into the insertion part 120. In addition, horizontal and vertical corrugations may be formed in the insertion part. Here, the vertical corrugations may have a function of expanding the size of the insertion part, and the horizontal corrugations may have a function of improving the grip performance of the insertion part.

The heat-resistant holder according to one embodiment may be formed of a flexible material having heat resistance, elasticity, and frictional force, such as rubber or silicone material, and the expansion of the insertion part 120 may easily occur due to the cutting portions C.

FIG. 3 is a view of a state in which a pot lid is placed upside-down by a user flipping the heat-resistant holder upside down while holding the insertion part of the heat-resistant holder according to one embodiment.

The user may put his or her fingers between the outer wall 130 and the insertion part 120, and while holding the insertion part 120, let a hot pot lid handle to be inserted into the insertion part 120, stably hold the hot pot lid handle, move the pot lid, and then bring the outer wall 130 into contact with the ground to place the pot lid. Then, the user takes his or her hand out of the heat-resistant holder through an empty space formed due to the wing 111 and the outer wall 130, and when using the heat-resistant holder again, puts his or her hand in the heat-resistant holder through the same empty space and then holds the insertion part 120 again for use.

Here, since the height of the outer wall 130 is formed to gradually increase from an elliptical portion of the support surface 110 toward the wing 111, a pot lid is able to be stably placed at a slant while a handle of the pot lid is caught in the insertion part 120, and it is also easy for the user to put his or her hand in and out of the heat-resistant holder.

According to one embodiment, a heat-resistant holder that allows a hot pot lid handle to be safely held can be provided.

According to one embodiment, a pot lid can be safely placed while a handle of the pot lid is inserted into the heat-resistant holder.

Exemplary embodiments have been disclosed above and illustrated in the accompanying drawings. Although specific terms are used to describe the embodiments herein, the terms are only used for the purpose of describing the technical spirit of the present disclosure and are not used to limit meanings or limit the scope of the present disclosure stated in the claims. Therefore, those of ordinary skill in the art should understand that various modifications and other equivalent embodiments are possible from the embodiments described herein. Therefore, the true technical protection scope of the present disclosure should be defined by the technical spirit of the appended claims.

1. A heat-resistant holder comprising:
a. a support surface;
b. an insertion part formed to have a shape that protrudes from one surface of the support surface; and
c. an outer wall formed to protrude along an edge of the support surface,
d. wherein a handle of a pot lid is inserted from the other surface of the support surface into the insertion part, and
e. the outer wall, which protrudes from the support surface, is configured to be open in one direction to allow a user's hand to enter and exit.

2. The heat-resistant holder of claim 1, wherein a height at which the insertion part protrudes is configured to be lower than a height at which the outer wall protrudes.

3. The heat-resistant holder of claim 1, wherein a height of an uppermost end of the outer wall is formed to vary according to positions in at least one region.

4. The heat-resistant holder of claim 1, wherein:
a. the outer wall includes a front outer wall that protrudes from a front edge of the support surface and a left outer wall and a right outer wall that protrude from a left side surface and a right side surface, respectively, of the support surface to face each other; and
b. heights at which the left outer wall and the right outer wall protrude gradually increase away from the front outer wall.

5. The heat-resistant holder of claim 1, wherein one or more cutting portions for expansion of the insertion part are formed in a region where the insertion part and the support surface come into contact.

6. The heat-resistant holder of claim 1, wherein the insertion part includes a corrugated structure formed on both inner and outer surfaces of the insertion part.

7. The heat-resistant holder of claim 1, wherein a thickness of the insertion part is smaller than a thickness of the outer wall.
